(19) United States
(12) Patent Application Publication
(10) Pub. No.: US 2010/0141202 A1
(43) Pub. Date: Jun. 10, 2010

(54) Apparatus for Converting and Storing Energy

(76) Inventors: Peter Spies, Herzogenaurach (DE); Guenter Rohmer, Erlangen (DE); Jens Tuebke, Waldbronn (DE); Christopher Hebling, Freiburg (DE); Harald Boettner, Freiburg (DE)

Correspondence Address: GLENN PATENT GROUP, 3475 EDISON WAY, SUITE L, MENLO PARK, CA, 94025, US

(21) Appl. No.: 12/516,517

(22) PCT Filed: Nov. 21, 2007
(86) PCT No.: PCT/EP07/10091

§ 371 Date: Jan. 19, 2010

(30) Foreign Application Priority Data
Nov. 27, 2006 (DE) 10 2006 055 883.9

(51) Int. Cl. H01M 10/46; H02J 7/00

(52) U.S. Cl. 320/101; 320/128; 320/108

(57) ABSTRACT

An apparatus for converting and storing energy, which includes a plurality of various energy converters for converting energy, which is present in various forms of energy, to electrical energy. The apparatus further includes an energy store for storing the electrical energy and an interface for outputting the energy to a consumer.

### CROSS-REFERENCE TO RELATED APPLICATIONS

This application is a U.S. national entry of PCT Patent Application Ser. No. PCT/EP2007/010091 filed 21 Nov. 2007, and claims priority to German Patent Application No. 102006055883.9-34 filed on 27 Nov. 2006, which is incorporated herein by reference in its entirety.

### BACKGROUND OF THE INVENTION

The present invention relates to apparatus for converting and storing energy as are found increasingly in mobile terminal devices.

For their energy supply, mobile terminal devices have a suitably dimensioned energy store, such as a battery or an accumulator. Said energy store may be recharged at regular intervals and thus considerably restricts the mobility of the user. Mobile terminal devices such as cellular telephones, digital cameras, portable computers, PDAs, clocks, etc. differ in their energy requirements, but have in common that they have an energy store, mostly in the form of a battery, which may be recharged or replaced at regular time intervals which depend on the utilization of the respective terminal devices. The energy store, e.g. the battery, supplies the electronic circuits of the terminal device with energy and may be recharged or replaced in dependence on the capacity and the consumption of the terminal device, which is cumbersome, restricts the user's mobility, or may negatively affect a user's satisfaction, depending on the case of application. In many cases, recharging the energy store involves using a charger, which in most cases is external and which may be connected to the mains supply for a specific time period and in dependence on a charging current and on the capacity to be recharged. It is particularly during said recharging phases that the mobility of the terminal device is restricted considerably or is not longer existent.

First approaches of a mains-independent energy supply utilize energy converters such as solar cells or heat generators, or heat converters, which may obtain energy from the environment for supplying and recharging mobile terminal devices. The precondition for this is the presence of the energy form to be converted, such as light, for example sunlight, or heat, which in turn is dependent on the application and environment. This severely limits the field of application of such alternative energy converters.

It is not known that coverage of the energy that may be useful for entirely self-sufficient operation were accomplished by such an energy converter. Depending on the power consumption and the application environment of a mobile terminal device, the energy supply system may be re-dimensioned and optimized, so that the supply of a mobile terminal device with energy cannot be realized using one single mains-independent energy converter.

For example, utilization of a cellular phone cannot be tied, in view of customer satisfaction, to the presence of, e.g., sunlight or a minimum temperature. The spectrum of mobile terminal devices is constantly being enlarged, for example by navigation devices, mobile TV sets, etc., so that for the various terminal devices, an accordingly broad spectrum of different energy stores and different charging regulators is useful.

A further disadvantage of current energy stores is that mutual replacement or substitution of the energy stores of various devices does not take place for reasons of the compatibility of the energy stores, which differ considerably in terms of their capacities, their volumes and their shapes. In addition, the possibilities of connecting the currently known energy stores are extremely different, so that mutual compatibility is non-existent also because of the diversity of said connection possibilities.

A further disadvantage of current energy supply approaches in mobile terminal devices is that it is only at large-scale technical expenditure and with significant loss that the energy from a mobile energy store can be passed on to another energy store.

DE 103 33 828 A1 discloses a means for energy generation, energy storage and energy provision to carrier containers, in particular with briefcases, suitcases and bags, which means stores a conversion of natural energy sources such as solar energy, physical kinetic energy and energy generated by differences in temperature, and provides said energy for supplying locking and security means, operating and display means with energy, as well as for external energy consumption. Said means enables continuous provision of energy which is independent of differing conditions in energy generation.

DE 202 20 148 U1 discloses a mobile energy storage and energy supply means which exclusively converts energy from primary natural energy sources, for example solar energy and/or kinetic energy of the human body, to stored energy, and supplies energy consumers, which is characterized in that the control unit, which controls the energy sources via central energy storage and energy supply, is connected to at least one mechanical energy storage means serving as a main energy store.

DE 101 37 588 A1 relates to a display system for locally presenting information, said system comprising a central unit and at least one display means. The central unit contains a transmit means for wireless transmission of data to the display means. The display means comprises a receiver, an electronic controller connected thereto, a data memory for temporarily storing the data received, and at least one display, controlled by the electronic controller, for displaying the data transmitted and stored. In addition, the display means comprises a current supply unit for converting energy from the environment of electrical energy, as well as an energy store for temporarily storing the electrical energy and for supplying the electronic controller.

DE 20 2004 012 611 U1 discloses a modular, upgradable and functionally combined diagnosis system comprising self-sufficient current supply for monitoring objects to be charged, for determining the technical condition and the operating data of rail vehicles without any drive of their own.

WO 2004/090327 A2 discloses a supply unit for current and water on the basis of renewable energies. The supply unit consists of a box-shaped sectional frame, whose base side stands on wheels, a frame that is quadratic when seen from the top being arranged on the top side thereof, said frame containing a solar panel. Said panel can be hinged pivotally about a horizontal axis in the top side of the box-shaped sectional frame. A peripheral quadratic frame having the same size and containing a further solar panel is pivotally hinged on all sides of said quadratic frame so that a cube shape is formed from the five quadratic frames when they are in their pivoting position. The peripherally hinged quadratic frames can be pivoted onto the plane of the central quadratic frame and can be locked in said pivoting position with respect to the central quadratic frame. The box-shaped sectional frame contains several box-shaped modules which can be inserted in a drawer-like manner from one side and may be locked in the inserted position, said modules enabling different functions such as accumulation of solar and wind energy, processing of drinking water, pumping of water, supply of electrical power or direct current-hydrogen generation using fuel cells.

DE 196 15 943 A1 describes that in a multi-block robot system, the advantages of flexible multi-axes applications due to multi-block standard parts are to be exploited for low-cost generation of energy from solar and wind power, for energy storage and output of energy. To achieve this object, provision is made, in accordance with DE 196 15 943 A1, for multi-block standard parts to be formed which consist of flange clip-on housings with integrated solar units and clip-on flanges, and are clipped onto central housings which include built-in elements of solar electronics and voltage converters and are equipped, at the outer edges and on the rear side, with rotary flange plug connections, for the multi-block standard parts to be combined with solar units and multi-block articulated arms, with flange clip-on housings having a central, vertical support function, with horizontal composite flange clip-on housings, with multi-block articulated frames which are clipped together horizontally and vertically from flange clip-on housings with clip-on flanges, additionally with flange clip-on housings having integrated battery units which are clipped on one behind the other, form battery lines and self-sufficiently lock and unlock themselves by means of solenoid switches in the rotary-flange plug connections during battery replacement.

DE 197 14 512 C2 discloses a maritime power plant with production processes for generating, storing and consuming regenerative energy, the power plant comprising, on a common support structure, apparatus for generating energy by at least two different methods from the environment of the plant, such as heat from the sea, sea waves, wind power and solar radiation, while taking into account the conditions of the location, for a continuous energy flow, and the power plant being directly integrated into the system by means of at least one industrial process, or being connected in immediate proximity of same, and/or being operated, within a network of power plants, as part of a group of further maritime power plants located in an area common to them, and use being made of a submarine reverse-osmosis plant.

### SUMMARY

According to an embodiment, an apparatus for converting and storing energy may have: a plurality of various energy converters for converting energy, which is present in various forms of energy, to electrical energy; an energy store for storing the electrical energy; an interface for outputting the energy to a consumer; and an interface for combining with other apparatuses for converting and storing energy so as to increase an output power and storage capacity, the apparatus including edges, the interface for combining including contacts at the edges, which contacts are configured to electrically interconnect several apparatuses when several apparatuses are combined.

According to another embodiment, a method of converting and storing energy may have the steps of: converting energy, which is present in various forms of energy, to electrical energy; storing the electrical energy in an energy store; combining the electrical energy with electrical energy of an apparatus for converting and storing energy via contacts at edges of the apparatus, so as to increase an output power and storage capacity; and outputting the energy to a consumer.

According to another embodiment, a system may have: two apparatuses which are implemented in a cubic manner and are mutually arranged in a geometrical manner such that the interfaces for combining the two apparatuses are electrically connected to one another.

The present invention provides an apparatus for converting and storing energy which comprises a plurality of different energy converters for converting energy, which is present in various forms of energy, to electrical energy. The apparatus further comprises an energy store for storing the electrical energy and an interface for outputting the energy to a consumer.

The present invention further provides a method of converting and storing energy which comprises a step of converting energy, which is present in various forms of energy, to electrical energy, a step of storing the electrical energy in an energy store, and a step of outputting the energy to a consumer.

The core idea of the present invention is to combine various energy converters, such as solar cells, heat generators, mechanical energy converters, etc., with a suitable energy store, so that the resulting apparatus may be employed as a universal energy supply module for any mobile terminal devices. Therefore, the technical field of application of the present invention comprises any mobile terminal devices such as mobile telephones, digital cameras, PDAs, clocks, etc.—additionally, applications in combination with fixedly installed terminal devices are also feasible. Embodiments of the present invention may replace conventional rechargeable accumulators in terminal devices, which rechargeable accumulators may be recharged by being connected to the power system and thus may restrict a user's mobility in the case of mobile terminal devices. Embodiments may further comprise suitable interfaces which enable adapting the energy supply to any consumers, i.e. which enable combining several inventive apparatuses with one another so as to obtain corresponding energy efficiency. In this context, embodiments may comprise plug connections which may provide mechanical or electrical coupling. External contacts by means of which electrical couplings may be produced, for example by merely arranging them in a geometrical manner, e.g. stacking them or placing them next to one another, may also be employed in embodiments. Additional interfaces may further enable simple wireless transmission of the energy stored, so that such devices which are equipped with inventive modules may mutually exchange energy as may be useful. Likewise, the energy may be forwarded in a wireless or wired manner from a central storage module to other terminal devices, i.e. to any consumers.

### BRIEF DESCRIPTION OF THE DRAWINGS

Embodiments of the present invention will be detailed subsequently referring to the appended drawings, in which:

FIG. 1 shows a block diagram of an embodiment of the present invention;

FIG. 2 shows an embodiment of the present invention; and

FIG. 3 shows a combination of embodiments of the present invention.

### DETAILED DESCRIPTION OF THE INVENTION

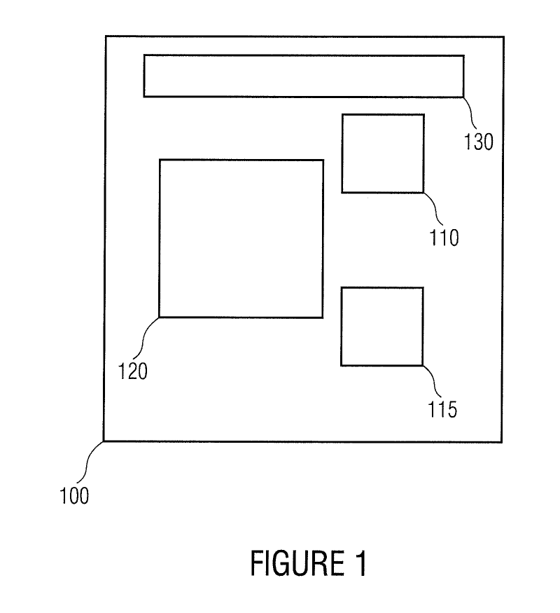

FIG. 1 shows an apparatus 100 for converting an storing energy. The apparatus comprises a plurality of various energy converters, two energy converters 110 and 115 being depicted in FIG. 1. The energy converters 110 and 115 serve to convert energy, which is present in various forms of energy, to electrical energy. The apparatus 100 further comprises an energy store 120 and an interface 130 for outputting the energy to a consumer.

Therefore, embodiments of the present invention represent a combination of several energy converters and stores, which may be provided with the corresponding open-loop and closed-loop control electronics, in a module which is scalable in terms of its size and, therefore, energy efficiency, and which consequently may be quickly adapted to different consumers. Embodiments may comprise modules which have suitable interfaces to be able to transmit energy to similar modules even in a wireless manner, as the case may be. Embodiments may further comprise interfaces for direct electrical coupling, such as contacts at the outer faces, along edges or surfaces, plugs or couplings or sockets. Embodiments may then also be electrically couplable to one another, for example by cables, plug connections or by merely being arranged in a geometrical manner. In addition, mechanical couplings, such as plug connections, locking means, even pushbuttons, etc., may also be provided.

One embodiment of the present invention therefore represents an energy supply module which, by means of a combination of different energy converters for any terminal devices, provides the energy that may be useful for self-sufficient operation. It further comprises an energy store wherein excess energy may be temporarily stored so as to bridge any operating periods when no convertible energy is available.

In addition, one embodiment of the present invention is universally applicable and capable of wirelessly transmitting energy to similar modules. By means of corresponding interfaces, several modules may be combined with one another so as to adapt the energy capture and the energy store to the requirements placed upon the environment by the consumer. Embodiments of the present invention are therefore scalable in terms of their sizes and their energy capacities, and may thus be adapted to any consumers.

The energy converters used in embodiments of the present invention, which are depicted as energy converters 110 and 115 in FIG. 1, may be realized by various energy converters such as solar cells and heat converters or other, further alternative generators or energy converters. In another embodiment, they may be integrated within one component. In addition, embodiments may comprise monitoring electronics which detect the amounts of energy provided by the respective energy converters, and which combine the energies provided, it being possible for the energy flow to be combined electrically, and the energy flows being made available to a consumer or an energy store in a direct or indirect manner. Embodiments may therefore be equipped with charging regulators which may be capable, on the one hand, of switching between individual energy converters or energy stores, and, on the other hand, of combining energy converters or energy stores, i.e., for example, of combining charging currents which have been generated, or of feeding them to various energy stores, or of adapting them.

Embodiments of the present invention may be combined into relatively large energy supply modules, it being possible for a relatively large energy supply module to consist of inventive units of identical design, all of which comprise the same system components, i.e. several energy converters, possibly regulators, stores, etc. Embodiments of the present invention further comprise interfaces, e.g. at their outer faces, so that any number of them may be combined with one another so as to increase the output power and storage capacity. Any geometrical shapes may be achieved by arranging the interfaces. For example, embodiments may take on cubic shapes, and may comprise contacts along their surfaces, for example along edges. Embodiments may then be electrically coupled to one another, for example, by mere stacking, while other couplings, such as by means of plug connections or holding magnets, etc., are also feasible.

In addition, embodiments of the present invention comprise interfaces for wireless data and energy transmission. Thus, energy exchange between adjacent devices are equipped with embodiments of the present invention is enabled.

In embodiments of the present invention, the energy store 120 shown in FIG. 1 may be realized, for example, by a capacitor or a supercapacitor. In this context, one embodiment comprises a capacitor whose capacitance is higher than one farad. Alternatively, the energy store 120 may also be realized by a fuel cell. In another embodiment, the inventive apparatus has a fuel cell as a buffer so as to bridge times when no convertible energy is available. In other embodiments, the energy store 120 may also be realized by an accumulator. Alternatively, the energy store 120 may also be replaceable, so that in this embodiment the inventive apparatus is realized as a charger for an energy store.

In accordance with the above explanations, the inventive apparatus has an interface 130 for outputting the energy to a consumer. In this context, the interface 130 may be configured for wireless or wired transmission of energy, for example by generating a magnetic or electric field. In other embodiments, wireless transmission of energy by means of other forms of energy is also feasible. One embodiment of the present invention further comprises a communication interface via which communication may be effected with terminal devices and other apparatus 100 for converting and storing energy. For example, communication may be performed, via the communication interface, with a terminal device in order to specify the manner of the provision of energy. Realizations of the communication interface are feasible both in a wired and in a wireless manner. Communication with other apparatuses 100 for converting and storing energy may serve, in embodiments of the present invention, to reconcile a combination, for example a parallel connection or series connection, of the individual apparatuses 100. Embodiments therefore enable a great variety of adaptations to most varied requirements on the part of the consumers. For example, voltages and currents may be combined and adapted to consumer requirements via various interfaces.

Further embodiments of the present invention comprise controllers for controlling the plurality of different energy converters, of the energy stores and of the interface, or communication interface. The controller may comprise, e.g., one or more charging regulators which regulate, or adapt, or combine, the energy transfer between the energy converters 110 and 115 and the energy store 120.

In one embodiment, the controller may also take on the task of monitoring the interfaces so as to monitor output of energy, or to coordinate it with other apparatuses 100 or terminal devices. For example, the controller might also communicate, via the communication interface, with other controllers in other apparatuses 100 or terminal devices.

A further embodiment of the present invention comprises a further energy store, which differs from the energy store 120 in the manner in which it stores the energy. For example, the inventive apparatus 100 might comprise, in one embodiment, a capacitor as the energy store 120, and might additionally comprise a fuel cell or a chemical energy store, etc.

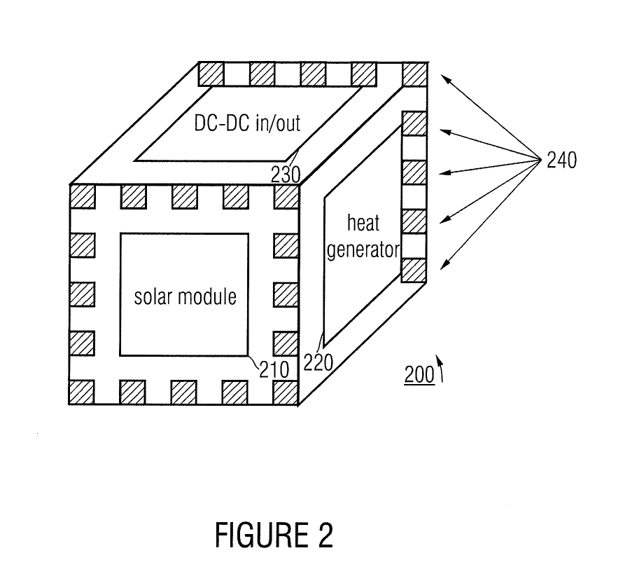

FIG. 2 shows an embodiment of the present invention, which will be referred to as a power cube 200 below. The power cube corresponds to a cubic implementation of an embodiment and comprises, e.g., a solar module 210, a heat generator 220, a DC-DC in/out (DC=direct current) regulator or voltage converter, as well as contacts 240 for combining several modules, which in FIG. 2 are schematically depicted at the front and rear sides of the module, i.e. power cubes.

The power cube 200 is an embodiment of the present invention and comprises a combination of the solar cell or the solar module 210, a heat generator 220, and a storage capacitor, an accumulator or any other energy store which is not shown in FIG. 2 and is located within the power cube 200. The solar cell 210 and the heat generator 220 are located on outer faces of the power cube 200 so that they are not covered up when several power cubes 200 are combined. Contacts 240, which, in case several power cubes 200 are combined, electrically connect same to one another, are located at the edges of the power cube. The voltage converter or DC-DC in/out 230, which adapts the output voltages of any combined power cubes 200 to one another, is located at a further outer face. The energy store, which may also be realized by a capacitor, a supercapacitor, or a fuel cell, for example, is located within the module or power cube 200. In addition, further open-loop and closed-loop control electronics may be located within the power cube 200. Integration of a micro fuel cell, which guarantees the energy supply, for example when no convertible energy is available from the environment, is also feasible.

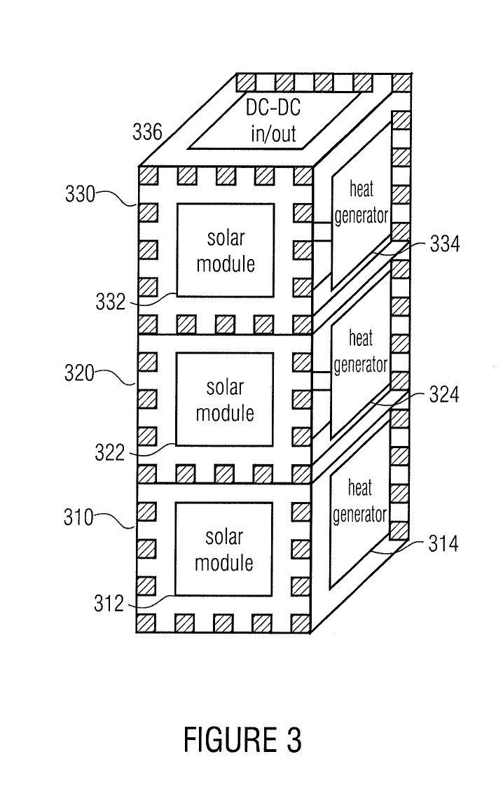

FIG. 3 shows a combination of three power cubes 310, 320 and 330, which correspond to the power cube 200 explained with regard to FIG. 2. Each of the power cubes 310, 320 and 330 depicted in FIG. 3 comprises one solar module 312, 322 and 332, and one heat generator 314, 324 and 334. In addition, each power cube 310, 320 and 330 comprises a voltage converter or a DC-DC in/out, only the voltage converter 336 of the power cube 330 being visible in FIG. 3. The power cubes 310, 320 and 330 depicted in FIG. 3 are electrically coupled to one another via contacts located at their bottom and/or top sides, so that they may suitably combine their energies. Thus, embodiments may also be combinable by simply being arranged in a geometrical manner, for example also by being stacked or by simply being placed next to one another.

The present invention offers the advantage that the combination of several energy converters, or power cubes, ensures that some kind of convertible energy is available at any time. In this manner, completely self-sufficient operation of a terminal device may be achieved.

A further advantage of the present invention consists in that, due to the ability to combine several individual modules, a suitably dimensioned energy supply module may be produced for each consumer in a fast and simple manner. Due to the scaling of an individual module which is achieved in this manner, the entire energy requirement of a consumer may be met.

In addition, embodiments of the present invention offer the advantage that on account of the wireless interface, energy may be exchanged between various terminal devices as may be useful. Due to the integrated charging electronics, the modules may also be recharged outside the terminal device. In this manner, any number of modules may be carried as backups, and may then be substituted for modules whose energy stores are depleted.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for converting and storing energy, comprising:
a plurality of various energy converters for converting energy, which is present in various forms of energy, to electrical energy;
an energy store for storing the electrical energy;
an interface for outputting the energy to a consumer; and
an interface for combining with other apparatuses for converting and storing energy so as to increase an output power and storage capacity, the apparatus comprising edges, the interface for combining comprising contacts at the edges, which contacts are configured to electrically interconnect several apparatuses when several apparatuses are combined.

2. The apparatus as claimed in claim 1, wherein one of the various energy converters comprises a solar cell or a solar module, a heat converter and/or a mechanical energy converter.

3. The apparatus as claimed in claim 1, wherein the energy store comprises a capacitor or supercapacitor.

4. The apparatus as claimed in claim 1, wherein the energy store comprises a capacitor comprising a capacitance of more than 1 farad.

5. The apparatus as claimed in claim 1, which comprises a fuel cell and/or wherein the energy store comprises a fuel cell.

6. The apparatus as claimed in claim 1, wherein the energy store is replaceable and/or comprises an accumulator.

7. The apparatus as claimed in claim 1, wherein the interface for outputting the energy is configured to transmit energy in a wired manner.

8. The apparatus as claimed in claim 1, wherein the interface for outputting the energy is configured to transmit energy in a wireless manner.

9. The apparatus as claimed in claim 1, wherein the interface for outputting the energy is configured to generate a magnetic field.

10. The apparatus as claimed in claim 1, wherein the interface for outputting the energy is configured to generate an electric field.

11. The apparatus as claimed in claim 1, further comprising a controller for controlling the plurality of various energy converters, the energy store, and the interface or a communication interface and/or a charging regulator.

12. The apparatus as claimed in claim 1, further comprising a further energy store, which differs from the energy store for storing the electrical energy in the manner of storing the energy.

13. The apparatus as claimed in claim 1, implemented in a cubic manner.

14. A method of converting and storing energy, comprising:
converting energy, which is present in various forms of energy, to electrical energy;
storing the electrical energy in an energy store;
combining the electrical energy with electrical energy of an apparatus for converting and storing energy via contacts at edges of the apparatus, so as to increase an output power and storage capacity; and
outputting the energy to a consumer.

15. A system comprising two apparatuses which are implemented in a cubic manner and are mutually arranged in a geometrical manner such that the interfaces for combining the two apparatuses are electrically connected to one another.
